(19) United States
(12) Patent Application Publication
(10) Pub. No.: US 2005/0131792 A1
(43) Pub. Date: Jun. 16, 2005

(54) Financial transaction system with integrated, automatic reward detection

(76) Inventor: Rick Rowe, Las Vegas, NV (US)

Correspondence Address: WEIDE & MILLER, LTD., 7251 W. LAKE MEAD BLVD., SUITE 530, LAS VEGAS, NV, 89128, US

(21) Appl. No.: 11/046,175

(22) Filed: Jan. 28, 2005

Related U.S. Application Data
(63) Continuation-in-part of application No. 10/091,381, filed on Mar. 4, 2002.
Application No. 10/091,381 is a continuation-in-part of application No. 09/497,788, filed on Feb. 3, 2000, now abandoned.

(51) Int. Cl. G06F 17/60

(52) U.S. Cl. 705/35

(57) ABSTRACT

A financial transaction system includes point of sale terminals having associated radio frequency tag or transponder detectors. The radio frequency transponder detectors are configured to read reward account code or information provided by a transponder. The system utilizes the reward or account code or information to generate discounts or awards for a transaction processed by the point of sale terminal. The system of the invention facilitates customer reward processing at the same time a purchase or transaction occurs. The invention also comprises various methods and system for creating and managing accounts, including reward accounts.

### RELATED APPLICATIONS

This application is a continuation-in-part of U.S. application Ser. No. 10/091,381, filed Mar. 4, 2002, which is a continuation-in-part of U.S. application Ser. No. 09/497,788 filed Feb. 3, 2000, now abandoned.

### FIELD OF THE INVENTION

The present invention relates to a point of sale system which includes radio frequency identification capabilities.

### BACKGROUND OF THE INVENTION

Accounts are utilized for a variety of purposes. Bank and credit card accounts have associated value and are used to facilitate financial transactions or exchanges. Commonly, however, accounts are being used for a wide variety of new and novel purposes.

Retailers are now commonly offering “reward” accounts. Retailers commonly utilize these accounts as an incentive for customers to provide personal information. This personal information may be utilized by the retailer to transmit advertisements. For example, a retailer may request that a consumer provide a postal or email address which the retailer may then utilize to direct print or electronic advertising to that consumer.

The retailer may also utilize the customer information along with purchase information to make business decisions. For example, using customer address information, the retailer may learn that customers in a certain geographic area purchase particular goods more often than consumers in other geographic areas. The retailer may thus customize advertising/sale information to target purchasing trends. The retailer may also make new product selections based upon the demographics of the customers.

In exchange for signing up for an account and providing information, a customer is generally offered discounts or other benefits. For example, consumer may be offered particular discounts on goods or services if they sign up with the retailer. Most often, the customer is offered the discounts at the point of purchase.

Various problems are associated with the implementation and use of these accounts. One problem is that the retailer must identify a customer who has an account in order to offer the customer these discounts. If the retailer does not distinguish between account-holding customers and non-account holding customers, then there is no incentive for customers to sign up.

Most often, customers are provided customer cards. An account number is associated with the card, that account number identifying the customer's account. When a customer makes a purchase, the customer must provide their customer card to the retailer. The retailer uses the account number on the card to verify that the customer is an account holder. The customer is then offered appropriate discounts for the purchases being made.

Each retailer offers their own accounts and associated cards. A consumer who frequents many retailers may thus have a great number of customer cards.

One particular downside to this arrangement is that the customer must have their card with them when they make a purchase in order to identify themselves. When the consumer has a reward account with a number of retailers, this may require that the consumer carry a large number of cards with them at all times.

Retailers have attempted to solve this problem unsuccessfully. Generally, customer cards are the same size as credit and similar cards. Some retailers offer “keychain” cards. These cards are smaller, but still must be carried to be used. Other retailers offer customers the ability to identify themselves by inputting their phone number into a keypad. This still requires action by the customer. In addition, if the customer's phone number changes, such as if they move, their number may no longer be valid.

In addition, these solutions do not address the problem of a customer having multiple accounts with many different retailers.

### SUMMARY OF THE INVENTION

One embodiment of the invention is a discount or reward system which includes radio frequency identification capabilities. In one embodiment, the discount or reward system is associated with or is part of a financial transaction system for processing the sale of goods and services.

In one embodiment, the system includes a plurality of point of sale or similar terminals. The point of sale terminals are configured to gather information from a payment media, such as credit card account information from a magnetic stripe of a credit card. This information is preferably used to complete a financial transaction associated with a commercial transaction, such as the sale of goods or services.

The system also includes one or more radio frequency identification device (RFID) tags or transponders, and one or more RFID tag readers or detectors. The RFID tags are configured to provide reward information, such as a reward or discount code or account number. The RFID reader is configured to read than information when an RFID tag is in sufficiently close proximity thereto.

Preferably, the RFID reader is associated with the point of sale terminal and is configured to provide the reward information to the point of sale terminal for use in determining eligibility for a reward or discount associated with the financial transaction being processed at the terminal. In one embodiment, the terminal is configured to transmit the reward information to a remote location, such as a retailer's central system. There the reward information is verified. If verified, discount, rebate or other reward information is generated. This information may be transmitted to the point of sale terminal, such as a discount to be applied to a purchase total, or may be stored, such as in the case of reward points.

In one embodiment, retailers or other providers generate reward or discount information, such as a discount code or account number. The RFID tag is configured to transmit the discount or account number. The RFID tag is provided to a consumer. For example, in one embodiment, a consumer may be required to “sign up” for a rewards program offered by a retailer. The sign up procedure may require that the consumer provide certain information and may result in the creation of one or more accounts.

Preferably, the RFID tag is configured to be associated with a support structure belonging to the consumer. In one embodiment, the RFID tag is associated with a carrier, such as a sheet of material. The carrier is configured to connect to a support structure, such as with adhesive. In this configuration, when the RFID tag is provided to the consumer, the consumer connects the tag to a desired support structure. In one embodiment, this structure is a credit, debit or financial card used to provide financial information. In this manner, when the consumer utilizes their credit or debit card to pay for goods or services, the associated RFID tag simultaneously provides reward or discount information.

The system may include or be associated with a retailer system which includes stored discount codes or reward account information which are used to verify codes or information transmitted by a consumer's RFID tag. The retailer system may also be configured to generate the discount or reward information in response to such verification.

In one embodiment, a consumer's rewards are associated with one or more accounts. A specific account may be created for a consumer and a consumer's rewards may be associated with that account. Various embodiments of the invention comprise methods of creating and managing accounts and rewards.

In one embodiment, multiple reward accounts are associated with or linked to a central or main account or a consumer has a single account which is recognized by multiple third parties, such as retailers. In this manner, a customer's financial transactions or reward events are centralized. In another embodiment, rewards created or generated by one or more retailers are associated with a single centralize account. In such an embodiment, a plurality of different retailers may all be associated with a common rewards system.

Further objects, features, and advantages of the present invention over the prior art will become apparent from the detailed description of the drawings which follows, when considered with the attached figures.

### DESCRIPTION OF THE DRAWINGS

FIG. 1 is a schematic diagram illustrating a system in accordance with one embodiment of the invention;

FIG. 2 is a schematic diagram of another system in accordance with the invention;

FIG. 3 illustrates RFID devices and a method of associating those devices with a card in accordance with an embodiment of the invention;

FIG. 4 is a flow diagram illustrating a method of creating, accessing and utilizing accounts in accordance with the invention;

FIG. 5(a) is a flow diagram illustrating in detail a method comprising a step of establishing an account in accordance with the method illustrated in FIG. 5;

FIG. 5(b) is a flow diagram illustrating in detail a method comprising a step of activating an account in accordance with the method illustrated in FIG. 5;

FIG. 5(c) is a flow diagram illustrating in detail a method comprising a step of determining if access to an account is permitted in accordance with the method illustrated in FIG. 5;

FIG. 5(d) illustrates various flow diagrams of methods comprising a variety of methods of utilizing in accordance with the method illustrated in FIG. 5;

FIG. 6(a) is a schematic diagram of a system of the present invention.

FIG. 6(b) illustrates the flow of financial transactions into predefined transaction categories; and

FIG. 6(c) illustrates an example of a monthly financial account statement in accordance with the invention with three example transaction categories defined.

### DETAILED DESCRIPTION OF THE INVENTION

The invention a point of sale system including radio frequency identification capability. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

One aspect of the invention is a financial transaction system which includes radio frequency identification capabilities. In one embodiment, the system includes a plurality of point of sale or similar terminals, each terminal having an associated radio frequency tag or transponder detector. The point of sale terminals are associated with one or more financial servers. The radio frequency transponder detectors are configured to read radio frequency transponder information and utilize that information. Preferably, the radio frequency transponder information comprises customer information and that information utilized to generate discounts or awards for a transaction processed by the point of sale terminal. The system of the invention facilitates customer reward processing at the same time a purchase or transaction occurs.

The invention also comprises various methods and system for creating and managing accounts. The accounts may be financial or reward accounts. In one embodiment, multiple reward accounts are associated or linked to a central or main account or a consumer has a single account which is recognized by multiple third parties, such as retailers. In this manner, a customer's financial transactions or reward events are centralized.

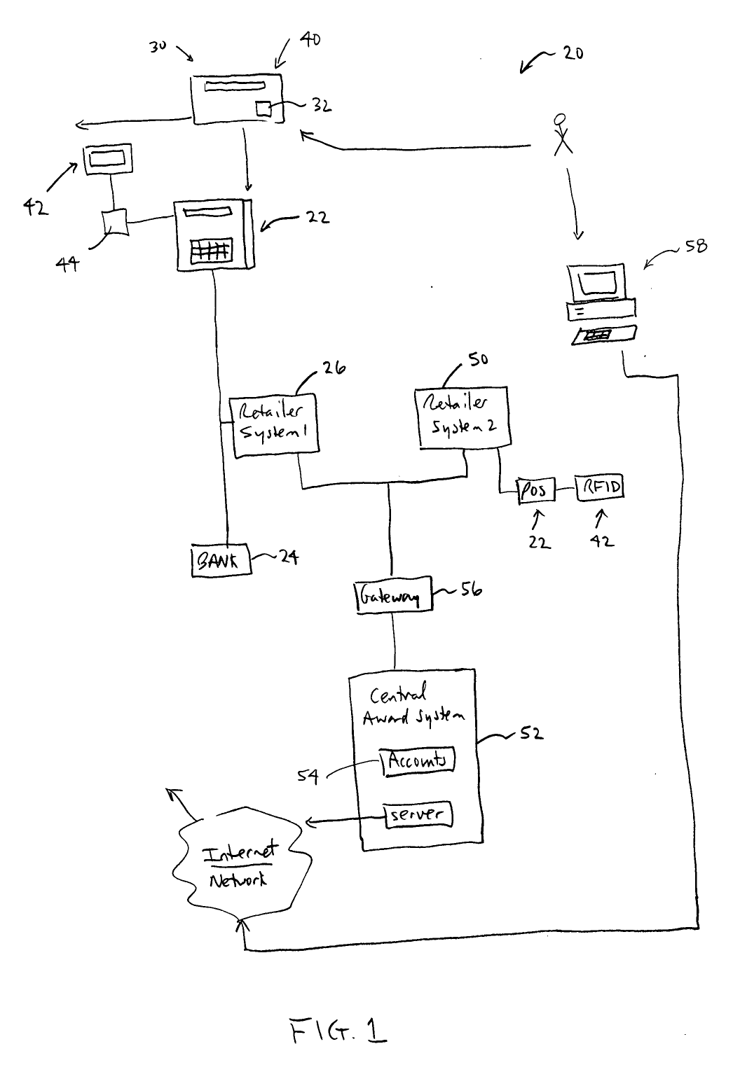

One embodiment of a system 20 of the invention is illustrated in FIG. 1. Preferably, the system 20 is configured to process financial transactions, such as those associated with commercial transactions including the sale of goods and services. In one embodiment, as illustrated, the system 20 includes one or more point of sale (POS) terminals 22. The POS terminals 22 may have a variety of configurations, as is known in the art. These terminals 22 generally include a media reader, such as device configured to read a magnetic stripe associated with a media such as a credit, debit or value card. In a preferred embodiment, the terminal 22 includes a communication interface and a controller. The controller causes information read from a media to be transmitted via the communication interface, and is capable of receiving information via the interface from a remote location.

The terminal 22 may be a stand-alone device or may be a computing device, cash register or the like. In such instances, the terminal 22 may be included or be associated with other elements, such a processor, data storage device, register drawer and the like. For example, such terminals 22 are generally associated with a means for registering information regarding one or more products to be purchased. This means may comprise, for example, a cash register including bar code reader and/or keypad which are used to input product codes and generate purchase information.

Regardless of its configuration, the terminal 22 is preferably configured to complete financial transactions. For example, the terminal 22 may be configured to transmit customer credit or debit card account information to a remote location for verification. Preferably, the information is utilized to verify the availability of funds (on deposit or available by credit or otherwise) to complete a financial payment transaction. The terminal 22 might include other financial transaction processing capabilities. For example, if associated with a cash register, cash payment may be entered to complete a purchase.

In one embodiment, the terminal 22 is configured to communicate with a financial institution 24, such as a bank, via a communication link. The financial institution 24 may be a credit card company, in the case where a credit card is used at the terminal 22.

In one embodiment, the terminal 22 is configured to communicate with a retailer system 26. For small businesses, the retailer system 26 may be a simple cash register or an on or off-site computer or computing system. For example, a cash register may generate an amount payable by a customer and transmit that amount to the terminal 22. The terminal 22 may then transmit amount due information along with customer financial information, to the financial institution 24 for use in verifying payment. Payment verification may then be provided to the cash register to complete the purchase.

In another embodiment, the retailer system 26 may include a remotely located computer or computing system. For example, in the case of a grocery store chain, the retailer system 26 may be a computing system at a headquarters thereof. Such a system 26 may be configured to transmit price information in response to input of a product code at the terminal 22, track inventory, price changes and accounting events including purchases and payments, which occur at one or more terminals 22.

This aspect of the invention comprises a financial transaction portion of the system 20. Essentially such a “financial” system is well known, and is simply configured to allow customers to effect payment for goods and services.

In accordance with the present invention, a radio frequency identification device (RFID) is associated with the POS terminal 22. The RFID preferably includes at least one reader configured to read or obtain information from an RFID tag or transponder.

Preferably, the RFID is configured to obtain such information from the media which is used with the POS terminal 22 in order to effect financial payment. In one embodiment, the RFID includes an RFID tag or transponder 32. The RFID tag or transponder is configured to be selectively associated with a media or other device/element. In one embodiment, the media may be, a credit, debit or other financial transaction card. Such cards are well known and thus will not be described herein in detail. In general, such cards are generally planar and have a front and back side, and a peripheral edge. The edge is generally rectangular in shape.

RFID transponders in general are well known. For example, one RFID transponder is manufactured and sold by Texas Instruments under the name “Tag-It” HF transponder. Preferably, the RFID devices herein comply with well defined industry standards such as that provided by EPCglobal, Inc. or International Organization for Standardization (ISO) specifications. This includes, but is not limited to, the EPCglobal, Inc. Gen 2 specification or the ISO 18000 series which describes the Air Interface parameters and acceptable communication frequency values and value ranges. It is well understood that such standards continue to evolve based on industry needs and compliance requirements, and it is contemplated that devices employing such new or later developed standards may be used with the present invention.

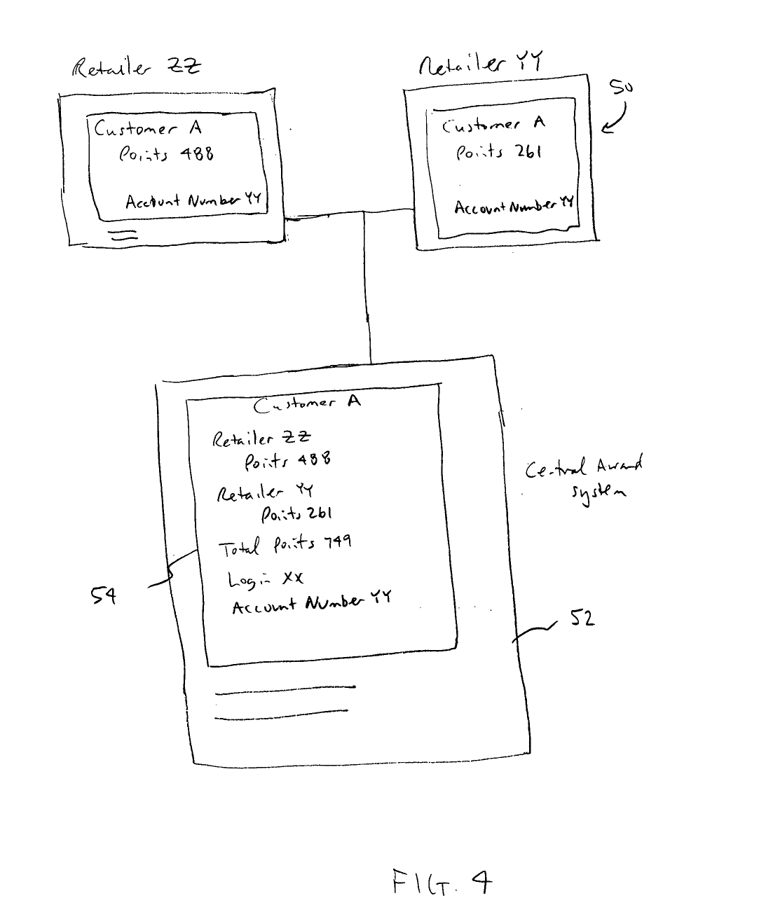

Preferably, a RFID device 30 of the invention comprises the RFID tag 32 and means for mounting the tag to another object or device. In one embodiment, the means for mounting may comprise an adhesive material associated directly with the RFID tag 32. In a preferred embodiment, the RFID tag 32 is associated with a carrier or body 34, and the carrier or body is configured to be connected to a support structure. For example, referring to FIG. 4, a RFID tag 32 may be connected to a body 34 comprises a backing or supporting sheet of material. The material may be, for example, aplastic or paper sheet. In one embodiment, adhesive 36 is located on a rear of the body 34 for connecting the body to a credit card or other support structure.

A cover may be selectively located over the adhesive to protect the adhesive when it is not in use. The cover may be removed when the body 34 is to be affixed to an object. FIG. 4 illustrates an embodiment where a cover 38 comprises a distribution card and the body 34 is affixed to that card and may be peeled or removed therefrom and then affixed to another object.

The RFID tag 32 may be associated with the carrier or body 34 in a number of ways. In one embodiment, the tag 32 may be connected with adhesive. The tag 32 may also be located under a protective sheet or other covering which holds the tag in place. The tag 32 might also be located between layers of the carrier 34 or otherwise be formed integrally with the carrier 34.

In a preferred embodiment of the invention, the RFID device 30 is configured for association with a support structure, and preferably a customer's credit, debit or other financial transaction card 40. In accordance with the invention, when a consumer signs up for a retailer's reward or similar program, the consumer is issued one or more RFID devices 30. Of course, these devices 30, since they include RFID tags or transponders 32, are preferably configured to transmit customer account information which identifies the customer and/or the customer's account.

In one embodiment, the customer is issued a sheet having the one or more RFID devices 30 mounted thereon. For example, the adhesive side of the body 34 of the RFID device 30 may be connected to a transporting sheet. The customer may peel the RFID device 30 from that sheet and then adhere it to one of their credit or debit cards. In the case where the customer is provided with more than one RFID device 30, the customer may connect the devices 30 to different cards.

The customer may also connect the RFID device 30 to other objects than a credit or debit card. For example, the customer could connect the RFID device 30 to a carrier, such as a blank card, a business card, a purse, wallet or other object. Preferably, the RFID device 30 is mounted to an object which will be in close proximity to the POS terminal 22.

As will now be appreciated, it is preferred that the RFID device 30 be slim in profile. In this manner, when the RFID device 30 is attached to an object such as a credit or debit card, the device does not substantially increase the size or profile of the card and interfere with its use or storage. As indicated above, it is desirable for the RFID tag or transponder 32 to be a thin foil type, and for the body 34 to which it is attached to be a tape or similar material, thus contributing to an RFID device 30 having a very thin profile.

Referring again to FIG. 1, in a preferred embodiment, a system 20 of the invention includes one or more RFID readers or sensors 42. Such readers 42 are well known and include an antennae.

Preferably, at least one RFID reader 42 is associated with and located in close proximity to a point of sale terminal 22. In this manner, the customer account information may be obtained from the customer's RFID device 30 when the customer engages in a financial transaction.

In one embodiment, the RFID reader 42 is configured to transmit customer account information to one or more remote device for use thereby. Referring to FIG. 1, the RFID reader 42 is configured to output customer account information to a retailer system or device 26.

In a preferred embodiment, the RFID reader 42 interfaces with the point of sale terminal 22. In this manner, the RFID reader 42 directly transmits customer account information to the terminal 22, and which in turn communicates that information with the retailer system 26 via its communication interface.

In one embodiment, the RFID reader 42 interfaces with the point of sale terminal 22 through an intermediate interface 44.

In accordance with the system 20 thus described, a reward or other account is created or generated and is associated with a customer. The account may simply be an identifier, such as a code, or may have a variety of data associated therewith. For example, in the case of a discount account, the account may simply be a code which validates entitlement of the customer to particular discounts. Preferably, however, customer information is associated with the account. This information may comprise, but is not limited to, the customer's address, telephone number and/or name.

The customer is issued one or more RFID devices. The customer associates the one or more devices with one or more objects. Preferably, the objects selected are those which are in the possession of the customer when the customer normally makes purchases from the retailer. In a preferred embodiment, the RFID devices are associated with credit or debit cards used to facilitate the financial transaction associated with the purchase.

When a customer engages in a transaction with the retailer or other entity, the customer account information is read by the RFID reader. For example, when the customer is standing in a check-out line, the customer account information is read from the RFID device which is associated with the object the customer attached it to. As indicated, this may be a credit card or other object, such as a purse or wallet.

The customer account information is read by the RFID reader and is provided to the retailer system. In one embodiment, the account information is transmitted to the point of sale terminal at the location where the transaction is occurring. Preferably, the retailer uses the account information to verify that the customer is an account holder. The retailer may then offer discounts or other awards to the customer. For example, once the customer is verified as an account holder, the discounts, credits or the like may be reflected at the point of purchase. The customer is then required only to pay the discounted amount in order to complete the transaction.

The retailer could also offer point or other benefits. For example, if a customer is confirmed as an account holder, the retailer may associate points with the customer's account. Those point may be based on the value of the goods purchased, the type of goods purchased or other factors. The points may be utilized for a variety of purposes, such as for obtaining discounted or free goods or services at a later date, among other things. Such reward programs are known.

Another aspect of the invention will now be described with reference to FIG. 1. As described in greater detail below, one aspect of the invention is the ability of a consumer to manipulate accounts, including merging accounts. With respect to the reward scheme described above, grocery store A may have a particular rewards program, as may pet store B. The consumer may sign up for both rewards programs. As described, the consumer may be issued an RFID device by each of those retailers. The consumer may conveniently associate those two RFID devices with their credit or debit card. When the consumer visits either grocery store A or pet store B, the appropriate RFID device is recognized by the particular retailer.

In some situations, it may be desirable to allow the consumer to access information regarding their account. For example, some retailers award points, credits or the like, such as based upon the value of a consumer's purchase. The points or credits may be associated with the consumer's account and be used by the consumer to obtain discounted or free goods/services. Thus, it may be desirable to allow the consumer to access the accrued point or credit information associated with their account so they may assess how many points they have accrued and whether they wish to utilize those points or credits. In addition, multiple retailers may wish to participate in a single, aggregated or centralized reward system. For example, grocery store A and pet store B may wish to participate in a single reward system by which the points or credits they issue can be aggregated by a consumer. This is a benefit to the consumer, as it reduces the number of different rewards programs which the consumer must track and allows the consumer to aggregate points or credits to achieve rewards at a faster rate.

FIG. 1 illustrates one embodiment of a system 20 which may be utilized to accomplish these and other functions. As indicated above, the system 20 includes a retailer system 26 which is linked to one or more RFID readers 42. Preferably, those readers 42 are associated with point of sale terminals or devices 22.

In a preferred embodiment, the system 20 includes at least one additional retailer system 50. Of course, there may be as many as one additional retailer system or a plurality of additional systems associated with the system 20.

In one embodiment, as illustrated, particular point of sale terminals 22 and associated RFID readers 42 are associated with the particular retailer. In this configuration, when an RFID reader 42 detects an RFID device, the account information is read and transmitted to the corresponding retailer system 26,50.

Preferably, however, the system 20 includes a central award system 52. The central award system 52 preferably comprises one or more computing devices. Preferably, the system 52 includes at least one data or information storage device, such as an electronic memory, and at least one communication device, such a server with a communication transceiver.

In one embodiment, the central award system 52 is configured to store customer account information. A consumer may create a unique account with the central award system 52 or the account may be identified with the consumer's retailer account information. In either event, an account 54 is preferably created and information is associated with that account. In one embodiment, the account simply comprises an electronic file, files or other data or data structures. The account may be identified by an account number or other identifier.

Preferably, the information or data which is associated with the consumer's account comprises data regarding the consumer's retailer or vendor accounts. For example, in the example illustrated in FIG. 1, data may be provided from the retailer system 26 and/or retailer system 50 to the central award system 52. The data pertaining to a particular consumer is preferably associated with that consumer's account 54. For example, consumer credit, point, discount or other information may be associated with the consumer's account 54.

In one embodiment, as detailed below, the information may be categorized, aggregated or otherwise manipulated or altered. For example, as one aspect of the invention, the information which is associated with the consumer's account may be configured to permit the consumer to view or access on an individual retailer/vendor account basis. In another embodiment, information relating to multiple accounts may be aggregated. For example, if two different retailers permit, the points or credits which are offered by two or more different retailers/vendors may be aggregated.

For example, referring to FIG. 4, a consumer may be long to the rewards club of Retailer ZZ and thus have an account therewith. The account may have an account number associated therewith, as well as consumer identifying information (such as address/telephone number, as described above). Similarly, the consumer may belong to the club of Retailer YY and thus have an account therewith.

These retailers may transmit information from their systems to the central award system 52, such as when a transaction occurs or the account is updated, or in response to a polling signal from the consumer. Information may then be associated with the consumer's account at the central award system 52. As illustrated, the consumer's account may include information regarding the consumer's account with each individual retailer and/or aggregated information, such as aggregated point information.

Preferably, the central award system 52 is linked via a communication link to the retailer systems 26,50 at one or more times. In this manner, information may be transmitted between the retailer systems 26,50 and the central award system 52.

The embodiment system 20 illustrated in FIG. 1 is particularly applicable to an arrangement where the retailer systems 26,50, including the reward systems or functions, are separate. In such a situation, the retailer systems 26,50 may include disparate components and operate using different programs or protocols. In such a situation, a gateway 56 may be provided between the central award system 52 and any or all of the retailer systems in order to permit communications therebetween. The gateway 56 may thus act as a ‘translator’ to the communications/data being exchanged between the retailer systems 26,50 and the central award system 52. As described below, in another embodiment, the entire reward system may be centralized.

In one embodiment, the consumer is permitted to access information regarding their account at the central award system 52. For example, as illustrated, the central award system 52 may comprise a server or other computing device including a communication interface. That interface may be linked to a communication path, such as the Internet. A consumer may transfer data to or obtain information from the central award system 52 via that communication path.

For example, the consumer may access a computing device 58 which similarly has a communication interface linked to the Internet. The consumer may be permitted to access information about their account by logging into their account.

In various embodiments of the invention, the consumer may establish an account with the central award system 52 provider. Various methods of creating and accessing accounts are described below.

In this manner, a consumer may obtain information regarding their accounts with various retailer or vendors. This information may comprise, but is not limited to, the identity of the retailers, and account information such as offered discounts, awarded points and the like.

In one embodiment, the retailers or other vendors may cooperate to create the central award system 52. In another embodiment, the central award system 52 may be created and operated by a third party. For example, a third party may offer as a “pay” service the aggregation and/or tracking of a consumer's accounts with various retailers/vendors and/or the access to that information.

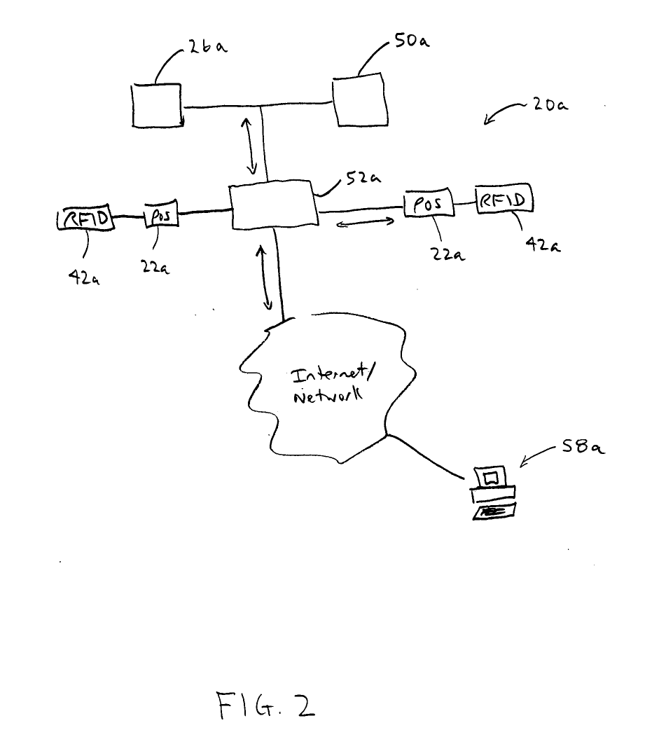

Another embodiment of a system in accordance with the invention is illustrated in FIG. 2. In one embodiment, information obtained from RFID devices 30 is preferably transmitted to the central award system 52a. The central award system 52a may identify the retailer with which the account is associated and then transmit that information to the particular retailer with which the account is associated, or may simply transmit the RFID account information to all retailer systems. In this system, the RFID readers/sensors and associated components need not be specifically associated with only a single retailer system, but can be part of a “global” system.

The retailer utilizes the RFID account information to verify the customers account. The retailer may transmit discount or other information to the point of sale terminal 22a in response to receiving that information. In addition or alternatively, the retailer may update the customers account at account data stored at the retailer system 26a,50a, such as with points or credits.

In a preferred embodiment of the invention, a consumer enrolls for a single reward account with the central award system. In one embodiment, this entitles the consumer to rewards from all retailers associated with the system. In another embodiment, the consumer may be required to activate their account with particular retailers, such as by specifically enrolling for participation in each retailer or vendors portion of the program.

In either embodiment of the system of the invention, the end result is “consolidated” rewards for the consumer. In operation, a consumer may participate in a single rewards program associated with a plurality of retailers, or a multiple rewards programs offered by multiple retailers. In this manner, when a consumer engages in a transaction with any of a variety of retailers, the discount or reward is offered seamlessly to the consumer. As the transaction occurs, account information is obtained from the one or more RFID devices which have been issued to the consumer. That information is utilized to verify account participation at either the central award system or the particular retailer system with which the account is associated. Any discount or credit which is applicable to the current transaction may be transmitted to the point of sale terminal or be otherwise transmitted for application at the time of the transaction. Of course, the retailer's accounting records may record the transaction, including application of the discount, so that the retailer may track the accounting portion of the transaction. In addition, the account information may be utilized to generate any points, credits or other rewards.

As indicated, the system may be configured to permit the consumer to view and access account information. As described below, the consumer may be permitted to engage in a variety of account activities, including merging data, such as rewards points or credits. A consumer may be permitted to access the account to utilize credits or points to make purchases on-line, such as for free or at a discounted rate.

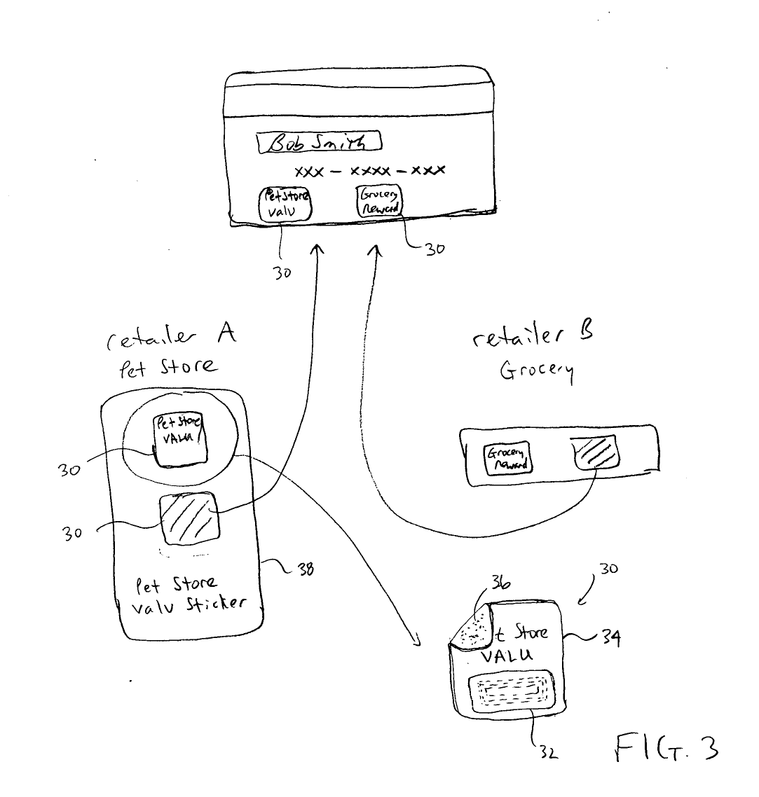

It will be appreciated that in the above-described systems, multiple retailers may each establish their own accounts and thus issue separate RFID devices 30, or they may issue common RFID devices. FIG. 3 illustrates a configuration where retailers each issued their own RFID devices. In such a configuration, a customer may have multiple RFID devices 30 associated with their credit/debit card or other element. In this instance, the central award system 52 operator may issue a single RFID 30 which is associated with and identifies a single centralized account.

As illustrated in FIG. 3, a retailer A, such as a pet store, may issue one or more RFID devices 30. As indicated above, in preferred embodiment, the RFID devices 30 may comprise RFID tags or transponders which have an attachment or coupling mechanism, such as by being associated with an adhesive backing or carrier. The RFID devices 30 may be issued on a carrier, such as a sheet. The consumer may disconnect an RFID device 30 and associate it with their credit, debit or other payment card or another support structure.

Similarly, other retailers, such as retailer B comprising a grocery store, may similarly issued one or more RFID devices 30 to a consumer. The consumer may associate one of those RFID devices 30 with the same card or other support structure as they associated the RFID device 30 issued by retailer A.

In this configuration, it will be appreciated that a consumer may associate one or a plurality of RFID devices 30 with the same card, carrier or structure. For example, the consumer may associate a plurality of RFID devices 30 with a single main credit card. In this manner, when the consumer uses the credit card at either retailer A or B, the appropriate associated RFID device 30 will provide the appropriate account information.

Of course, if a single RFID device 30 is associated with a plurality of retailers, then the consumer need only have one RFID device 30 in order for the system to operate as described above.

As indicated above, one aspect of the invention is the use of accounts for various purposes, including providing rewards. Various embodiments of the invention comprise methods of creating and using accounts. As indicated below, these accounts may be created in a number of ways, and have a number of purposes and types, including financial accounts used to facilitate purchases, and awards or rewards accounts.

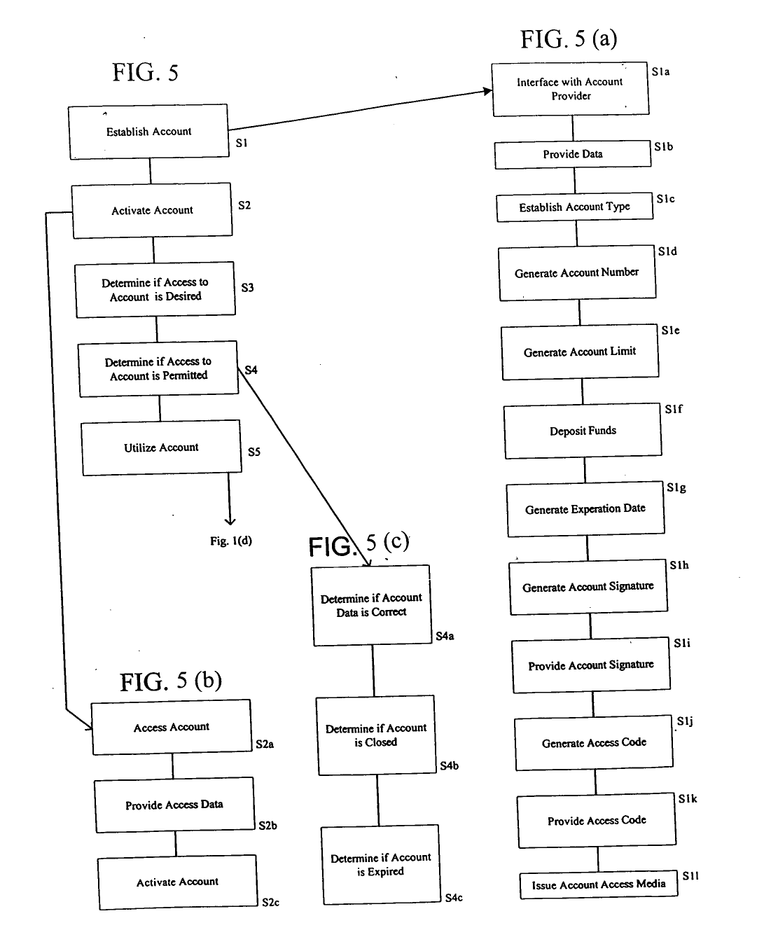

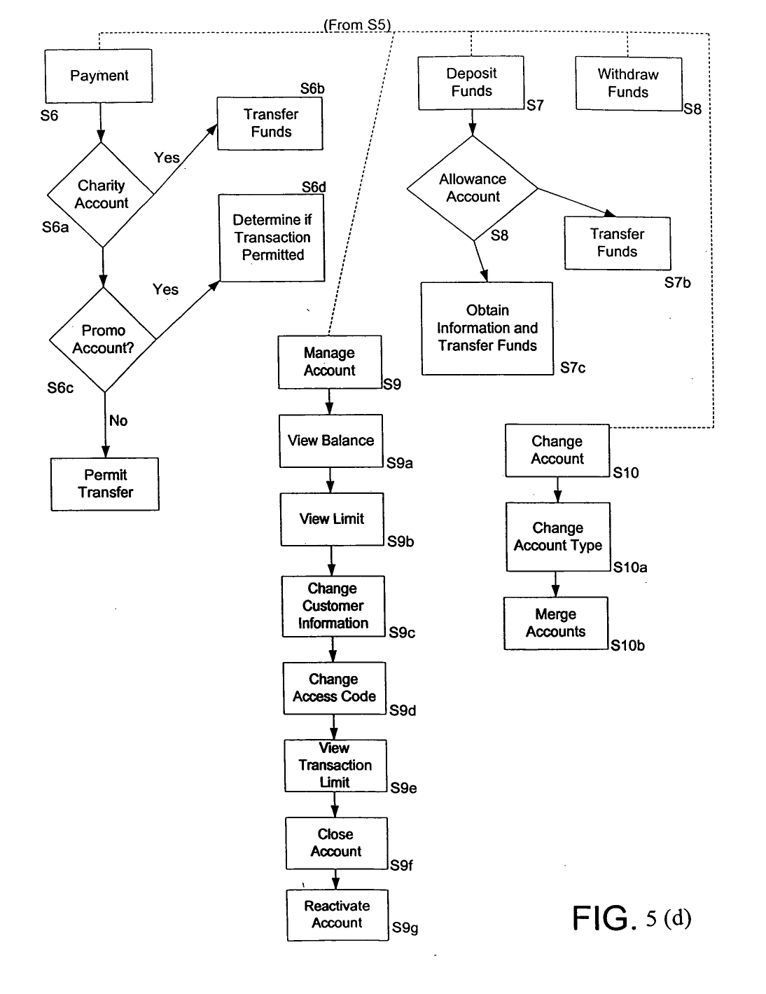

Referring to FIG. 5 in one embodiment of the invention an account may be established, as in a step S1. The account may be established by a party for use by themselves or for use by others. As used herein, the person who establishes the account is generally referred to as a customer, regardless of whether that person is establishing the account for themselves or another party or user.

The account is established by an account provider. The account provider may be a retailer, bank or other entity. As provided below, regardless of whether the account is referred to as a financial, bank, debit, monetary or other named account, the account has certain characteristics that define it.

Referring to FIG. 5(a) there will be described one or more methods for establishing an account. In a first step S1a, a customer interfaces with an account provider. This step may comprise the customer accessing a web site belonging to the account provider, calling an account provider customer representative, or accessing one or more other means now known or later developed by which the customer may provide information to the account provider. In the case where an account is established with a retailer, the methods may even include filling out a printed form.

In a step S1b, the customer provides data to the account provider. This data is used to set up the account. The particular data which is required may vary by provider. In one or more embodiments, the data may include the customer's name and/or the name(s) of the parties which are to be permitted to access the account, address, telephone number, social security number, birth date, mother's maiden name and/or other information. In the event the customer is a business, the information may comprise the business name, address, telephone number, taxpayer identification number and/or similar information.

The particular manner by which this information is transmitted to the account provider may depend upon the interface the customer is using. For example, the data may be input into a graphical user interface associated with the account provider's website and then sent to the account provider's computer, such as over the Internet. The data may be provided orally over the phone by the customer to the account provider.

In a step S1c, an account type is established. In one or more embodiments, the account type may comprise one or more of the following: customer debit, charity debit, promotional, or allowance account. The account may be of other types, however, such as a reward account with which points or the like are associated, as also described herein.

A customer debit account is preferably of the type where funds belonging to the customer are assigned or credited to the account, and payments, transfers and the like are associated with debits of these funds from the customer's account. This is opposite to a credit type account where those funds which are debited belong to the account provider or other creditor with the requirement that the customer repay the account provider with their funds at a date after a particular transaction. In general, the customer debit account permits a customer to make and pay for purchases, obtain funds (such as currency), and transfer funds into and out of the account.

A charity debit account is preferably of the type where the customer may only transfer funds from the account to an authorized charity or similar entity, with no other debits permitted (except return of the funds to the customer or transfer of funds to another account belonging to another account at the specific instruction of the customer). Generally, the customer will provide the account provider specific information about the charity to which funds are to be transferred. The customer may arrange the account such that funds are debited and transferred to the charity at one or more predetermined times and for one or more predetermined amounts.

A promotional account is preferably of the type where the customer is a promoter arranging an account for use by one or more other parties. For example, the promoter may be a store owner and the parties who may use the account may comprise customers or potential customers of the store. The promotional account is arranged so that the parties or users may access the account in accordance with the terms of a promotion offered by the promoter. A promoter may establish an account having funds permitting a number of parties to pay for a certain dollar amount of goods purchased at their store via the promotional account. For example, a promoter may establish a promotion for a number of parties, such as 1000 existing customers, whereby $10 of each purchase from the promoter over $20 is payed for by the promoter. The $10 payment may be debited from the promotional account at the time each party makes a qualifying purchase to credit the parties' payment of the goods or services.

An allowance account is preferably of the type where funds are arranged to be periodically transferred into the account. Such an account may be extremely useful to parents having children. In accordance with this account arrangement, funds are periodically transferred into the account for subsequent use. The funds may be transferred from another established account, or an account or other source not associated with the account provider. For example, parents may establish a customer account from which funds are periodically transferred, such as every two weeks, into an allowance account which is accessible by one or more of their children. These children may access the allowance account to pay for books and the like. In this manner, the parents may control (and as described below, track) the spending of their children or other parties which have access to the account.

Those of skill in the art will appreciate that the particular type(s) of accounts and their various features or characteristics may be different than those provided above. For example, an account may have one or more features associated with more than one of the account types provided above.

In a step S1d, the account provider generates an account number and associates the account number with the account. The account number may be used by the account provider and customer to identify the account.

In a step S1e, if the account is a “funds” account, the account provider preferably assigns the account with a maximum funds value or value limit. In general, this value may be selected by the customer. Most often, the maximum value will comprise the amount of an initial deposit into the account by the customer. In one or more embodiments, the account provider may only offer accounts having pre-set limits, such as $50, $100, $250 or $500.

In a step S1f finds are deposited into the account. Preferably, the maximum amount of funds which may be deposited into the account does not exceed the funds maximum value associated with the account.

In one or more embodiments, the customer provides data which permits the account provider to obtain funds electronically. In one or more embodiments, this comprises providing the account provider with a routing number for a checking or savings account at a bank, account and access information for an ATM card linked to an account, or a credit card. In one or more embodiments, a customer may be permitted to deposit funds by mail or similar non or partially non-electronic manner.

Again, if the accounts is a “funds” account, in a step S1g, the established account is preferably assigned an expiration date. In one or more embodiments of the invention, this step comprises associating date data with the account. The expiration date may be generated in a wide variety of manners. The expiration date may comprise a date which is determined by adding a fixed period of time to the date on which the account is established or, as described below, the date on which the account is activated. As described below, the account is arranged such that when the actual date reaches the expiration date, the account can not be accessed except by the account provider.

In a step S1h, an account signature is generated and associated with the account. The signature comprises a unique code or other element for establishing entitlement to access the account. In one or more embodiments, the account provider generates the code based on one or more elements of data associated with the account, such as customer provided data, the initial funds deposit amount, the account number, the account expiration date and/or one or more other elements. In one or more embodiments, the account signature is generated from, or includes, an access code or personal identification number (PIN) data assigned to or selected by the customer as described below. In one or more embodiments, the data used to generate the signature may be input into an encryptor to generate an output which comprises the account signature. The account signature may be generated randomly as well. Preferably, whatever means is used to generate the signature, each signature is unique for a particular account.

In a step S1i, the account signature is provided to the customer. In one or more embodiments, the account signature is mailed to the customer, told over the phone by a customer representative of the account provider to the customer, or is transmitted electronically to the customer. As described below, in the event the customer is provided with an account access media, then the account signature may be provided on the account media. The account signature may be printed on, embossed in, or encoded on the account media or an element associated therewith.

In a step S1j, an account access code is generated and associated with the account. In one or more embodiments, the account provider generates the access code. In other embodiments, the customer generates the code and provides it to the account provider. The access code may comprise a personal identification number or “PIN” comprising one or more letters and/or numbers.

In a step S1k, the access code is provided to the customer. In the case where the customer selects the access code, this step is completed at the same time as step S1h. When the account provider generates the code, the code may be mailed, electronically transmitted or spoken to the customer.

In a step S1l, in one or more embodiments, the customer is provided with an account access media. The access media may comprise a card, check, ticket, chip or a wide variety of other items. In one or more embodiments, the account signature is associated with the access media. When the access media comprises a card, check or the like, the account signature and/or account may be printed or encoded thereon. The account signature may be provided in one or two-dimensional bar code form or be encoded in a magnetic stripe or a chip or other data storage element associated with the media.

The account signature and/or access code may comprise a physical characteristic of the customer. For example, the access code may comprise a fingerprint or the customer's retinal features. In general, the account number, signature and access code are for use in identifying the particular account and ensuring that only those parties with authority to access an account can do so. A variety of other methods and devices may be used for these purposes.

A variety of other steps and may be associated with the establishment of an account for the customer, and the steps described above need not be completed in the order in which they were described.

Referring again to FIG. 5, in a step S2, an account which the customer wishes to access is activated. Normally, this step will be in response to a customer wishing to access a newly established account.

Referring to FIG. 5(a), there is illustrated one embodiment of a method of activating an account in the event the account has not been activated. In a first step S2a, the customer accesses the account. In one or more embodiments, this step comprises a customer contacting the account provider, such as via a website of the account provider or by telephone with a customer service representative.

In a second step S2b, the customer provides their account number, signature and, in one or more embodiments, the access code. This account identification and access data may be provided by a customer telling an account representative the information, typing the information into a data input accepting element of a graphical user interface of a website, or otherwise transmitting such to the account provider. In one embodiment, the account number and signature may be scanned off of an account media provided the customer, such as with a magnetic stripe or bar code reader.

In a step S2c, the account provider activates the account. In one or more embodiments, this step comprises associating data with the account which indicates that the customer and/or other designated and/or appropriate parties may utilize and access the account.

The account activation may be accomplished in a wide variety of other manners. For example, in one embodiment, a customer may activate an account by simply calling a phone number of the account provider or entering the appropriate data into the account provider's website. In this arrangement, it is not necessary for the customer to access the account or provide all of the account information which may be necessary for the customer to use the account.

In one embodiment, an account may be activated for use by a customer at the time it is established. In such an arrangement, any access media associated therewith may be separately activated. For example, the account may be activated when established, allowing a customer to make deposits, funds transfers or the like through an account provider representative or website. However, the customer may not be permitted to utilize an account media (such as for purchases or cash withdraws) until the customer activates the account as to the media. The customer may activate an access card by calling a representative of the account provider after the card is received or other means.

Referring again to FIG. 5, in a step S3 it is determined if a customer wishes to access an account, as by a customer's attempted use of the account. This step may be remote in time from step S2, or at the same time. For example, a customer may activate an account shortly after establishing it, but not access the account for several days or weeks thereafter. A customer may also wish to activate an account and utilize it at the same time, such as when the customer wishes to pay for a purchase at a store.

In one or more embodiments, this step comprises determining if a customer is accessing a bank, automated teller, customer service representative, account provider website, remote payment station or the like. In order to determine if the customer is attempting to access an account, particular account information and associated access data is required. This data may be provided to the account provider or other account access controlling entity in a number of manners. In one or more embodiments, the account information may be directly provided by the customer, as through data input into a website or spoken to an account representative, or by reading the information from the access media.

The customer may wish to access the account for a number of reasons. For example, in the event a customer wishes to complete a purchase from a vendor, such as on-line or at a store, the customer may seek to access the account to pay for the purchase. The customer may seek access to the account to obtain funds from an automated teller machine.

In one or more embodiments, data must be provided to the account provider to establish the entitlement of the customer to access the designated account. This information may comprise the account signature and/or access code. Again, the particular means and/or method by which this information is provided may vary. In an embodiment where a customer is seeking to access an account using an access media, the account signature may be read or scanned from the card, and the access code may be provided by the customer, such as through a keypad. The customer may also provide such information through a variety of data input devices, such as a computer or customer station at a store, or provide the information directly to an account representative.

When a customer wishes to access an account, in a step S4 it is determined if the access to the account is permitted. In one or more embodiments, and referring to FIG. 5(c), this step includes a step S4a of determining if the provided account access information is correct and complete. In one or more embodiments, this step comprises comparing the provided account identification and/or access information to that associated with the account which the customer is seeking to access. If the required information has not been provided or is not correct, access to the account is denied. The customer may then be directed to contact the account provider and/or attempt to re-enter the required data in case there was an error in providing or transmitting it to the provider.

If the requisite access information is provided, then in a step S4b, it is determined if the account is closed. If the account has been closed, then access to the account is denied. The account may be closed at the request of the customer, upon violation of account terms and conditions or for a wide variety of other criteria or reasons.

If the account is not closed, then in a step S4c, it is determined if the account is expired. The account may be determined to be expired if a current date is the same as or time-wise later than the expiration date assigned to the account. If the account is expired, the customer is not permitted to access the account directly. Preferably, in that situation, the customer may access the account only through the account provider. The customer may contact the account provider and arrange for the removal of any funds remaining in the account. Alternatively, the customer may be permitted to re-activate the account with a new expiration date.

If in step S4 it is determined that access is permitted to the account, then in step S5, the customer is permitted to utilize the account. As described below, a variety of transactions, interactions with and manipulations to the account are permitted.

Referring to FIG. 5(d), in one or more embodiments, in a step S6, a customer is permitted to utilize the account to make a payment to a third party. A variety of methods may be implemented to effectuate this step. In one or more embodiments, in a step S6a, it is determined if the account is a charity account. If so, in a step S6b, funds are transferred from the charity account to a selected charity.

In one or more embodiments, when a charity account is established, the account provider designates the account a charity account. At that time, a customer may designate one or more charities to which funds placed in the account are to be distributed to. These funds may be distributed in accordance with the specific instruction of the customer at a later date, or at a predetermined time or in accordance with a predetermine schedule. The amount of the funds to be distributed may be designated by the customer as well. In one or more other embodiments, the customer may designate the charity(ies) to which funds are to be distributed after the account has been established.

In one or more embodiments, the funds which are distributed to the charity are transferred electronically from the account by the account provider to an account belonging to the charity or an intermediate escrow account or the like from which the charity may obtain payment. In other embodiments, the funds may be mailed or transmitted in other manners.

If the account is not a charity account, then it is determined in a step S6c if the account is a promotional account. If the account is a promotional account, then in a step S6c, the account may be used to purchase or pay for goods from specific parties. Preferably, the account provider must verify that the purchase is being made from one of the authorized parties. Normally, when the purchase is being made, the vendor will transmit vendor identification information along with the customer's account information. The account provider can verify the vendor from the provided vendor information.

If in step S6c it is determined that the account is not a promotional account, then it is determined that the account is a customer or allowance account which may be used as the source of payment for a transaction with, in general, any party. In step S6e, the purchase or other transaction is then facilitated by debiting the account.

It will be appreciated that a variety of steps other than those described may be associated with the payment of a purchase from the account. For example, in one step, the account provider must generally verify that sufficient funds exist in the account to permit the transaction. If sufficient funds do not exist, then the transaction may not be permitted. Alternatively, as described below, the account may be provided with a “credit” or “overdraft” feature which would still permit the customer to access the account.

As part of the transaction, the particular vendor may send information which facilitates the transfer of funds from the customer's account to the vendor's account by the account provider. For example, this information may comprise a vendor identification or account number.

As provided above, the method and apparatus by which the customer accesses the account to facilitate a purchase may vary. For example, if the customer is purchasing goods at a store, the customer may swipe their access media through a card reader and enter their access code. If the purchase is through a web-site or similar on-line access, the data may be input into a graphical user interface of the site.

In accordance with one or more embodiments of the invention, the payment for purchase may be arranged as an automated debit from the account. For example, a customer may arrange for payments to be made from the account on a periodic basis, such as in response to monthly amounts due a party (such as for a car payment or the like). In such event, the customer may provide the necessary debit information to the account provider.

In one or more embodiments, a purchase may be made in the form of an automatic funds transfer. For example, a customer may arrange with a particular vendor an arrangement where payment for the goods or services is made automatically. The customer provides the vendor with the account data which is then used by the vendor at one or more times subsequent thereto to affect payment. As an example, a customer may provide account data to their electric company. The electric company may then receive payment for the electricity supplied to the customer each month directly from the account through the account provider without intervention by or acts required by the customer. In this embodiment, the step of the customer accessing the account, step S3, generally comprises the customer providing the account data to the vendor or other party and then the vendor accessing the account as agent of the customer.

As one aspect of utilizing the account, as illustrated in FIG. 5(d), in a step S7, in one or more embodiments a customer may deposit funds into the account. A variety of methods may be implemented to effectuate this step. In one or more embodiments, this step includes a step S7a of determining if the account is an allowance type account. If so, then in a step S7b, funds are periodically transferred into the account. If the account is an allowance account, a customer will have provided the account provider with a source of funds from which a transfer into the account is to be made. The source of funds may be a customer's credit card, a bank account, or another account in accordance with the present invention. The customer will also have provided the account provider with specific instructions as to when funds are to be deposited, in what amount and the like.

If the account is not an allowance type account, then in a step S7c, the customer must specifically arrange for the particular transfer of funds with the account provider. For example, the customer may access a web-site or customer representative and provide source funds data. This data may comprise credit card information, bank account and routing information or the like. The customer may also arrange for funds transfer between accounts at a bank or similar provided customer station, phone controlled system or the like.

As one aspect of utilizing the account, as illustrated in FIG. 5(d), in a step S8, in one or more embodiments a customer may withdraw funds from the account. A variety of methods may be implemented to effectuate this step. In one or more embodiments, the funds withdrawal may comprise the issuance of currency such as U.S. or other dollars, or other media. In one or more other embodiments, the withdrawal may comprise the transfer of funds to another entity or account.

In general, when the customer desires to obtain currency, the customer travels to an automated teller machine (ATM), bank or similar currency dispensing location. In such event, the step of providing the requisite account data (see step S3) may comprise swiping an account media and inputting an access code. In the event the customer does not have an access media, the customer may provide the requisite data directly to a teller or other bank personnel for input into a system.

If the customer desires to withdraw funds and have the funds transferred into another account, the customer may be permitted to do such over the phone, via the account provider's web site, or at a bank or other location. In this regard, the number of locations at which a customer may effectuate the transfer is not constrained to locations where currency can be dispensed.

If the customer requests funds, and if such funds exist in the account, the customer is provided with funds. This step may include the step of transmitting the fund request to the account provider and the account provider comparing the amount of funds requested versus the total amount of funds in the account. If the funds exist, then the account provider may send a signal or other indication that it is permissible to dispense the funds.

In one or more embodiments, the customer is permitted to request currency or a transfer. If currency is requested, then currency is dispensed. If a transfer is requested, then the funds may be transmitted electronically to a new account. In the event the funds are to be transferred to another account, the customer provides the necessary information, such as the receiving account number and/or routing number and/or receiving party information.

As one aspect of utilizing the account, as illustrated in FIG. 5(d), in a step S9, in one or more embodiments a customer may obtain account information and manage their account. A variety of methods and devices may be utilized to effectuate this step. For example, a customer may call an automated telephonic information system, call a customer service representative or access a web site belonging to the account provider. In one or more embodiments, certain information and transactions may be permitted through an automated teller machine or similar remote access site.

In one embodiment, this step may include one or more of the following steps. In a step S9a, a customer may be permitted to obtain their account balance. The account balance may be provided on a viewing screen or printed on paper.

In one or more embodiments, in a step S9b, a customer may obtain the account limit for their account. The limit value may be displayed to the customer if the customer is located at a display, or may be printed onto a media, such as paper, and dispensed or mailed to the customer. If the customer is utilizing a phone system, the information may be transmitted over the phone.

In one or more embodiments, in a step S9c, a customer may change information associated with their account. This information may comprise their name, address, telephone number, the name(s) of parties permitted to access the account and the like.

In a step S9d, a customer may change their access code or similar access information. For example, in one embodiment, the account provider may assign the customer the access code when the account is established. In accordance with this step, the customer may change this access code to a code of their selection.

In a step S9e, a customer may obtain information regarding transactions associated with the account. This information may include information regarding fund deposits, withdraws and other transactions. In one or more embodiments, the customer may obtain information regarding an amount paid or transferred out of the account, the date of the transfer and the party to whom the amount was paid or transferred. The customer may obtain information regarding an amount deposited or transferred into the account, the date of the transfer and the origin of the funds.

In a step S9f, a customer may close the account. When closing the account, the customer may indicate to the account provider the location to which any funds remaining in the account are to be transferred.

In a step S9g, a customer may re-activate an account in order to change its expiration date. For example, before an account expires, a customer wishing to utilize the account for a longer period of time may elect to re-set the expiration date for the account. In one or more embodiments, the date is automatically set by the account provider, such as by adding a period of time to the current expiration date or the current date. In one or more other embodiments, the customer may select a new expiration date in the future.

As one aspect of utilizing the account, as illustrated in FIG. 5(c), in a step S10, in one or more embodiments a customer may change the status of the account. A variety of methods may be implemented to effectuate this step. In a step S10a, a customer may change the account type, such as from a customer account to a charity or other account, or vice versa. In a step S10b, a customer may merge one account with another account. For example, a customer having two accounts may wish to merge the accounts into a single account. A customer having one account may establish another and then merge or eliminate the first account in favor of the second.

Several examples of account merging are provided below:

John Doe's Debit Accounts

| Account Type | Balance | Status |
|---|---|---|
| $250 Debit Account | $100 Remaining | Active until Jan. 1, 2001 |
| $150 Debit Account | $50 Remaining | Active until Apr. 1, 2001 |

After merging accounts into a new account:

John Doe's Debit Accounts

| Account Type | Balance | Status |
|---|---|---|
| $250 Debit Account | $0 Remaining | Closed |
| $150 Debit Account | $0 Remaining | Closed |
| $150 Debit Account | $150 Remaining | Active until Jun. 1, 2001 |

Alternatively, the owner of the accounts may wish to transfer the $100.00 remaining from the $250 account into the $150 account with $50.00 remaining. This would close the $250 debit account and establish a new balance of $150 in the $150 debit account. An example of this transaction is as follows:

John Doe's Debit Accounts

| Account Type | Balance | Status |
|---|---|---|
| $250 Debit Account | $100 Remaining | Active until Jan. 1, 2001 |
| $150 Debit Account | $50 Remaining | Active until Apr. 1, 2001 |

After transferring the remaining amount into the $150 account:

John Doe's Debit Accounts

| Account Type | Balance | Status |
|---|---|---|
| $250 Debit Account | $0 Remaining | Closed |
| $150 Debit Account | $150 Remaining | Active until Apr. 1, 2001 |

A customer may also be permitted to close the account. If the account is empty, the account is simply closed by the account provider so that further access to the account by the customer is prevented. In the event funds exist in the account, the customer may be provided with the option of transferring the funds to another location or account, or obtain the funds from the account provider by mail.

In accordance with one or more embodiments of the invention, the account provider may provide a credit line or “overdraft” protection for the account. This option may be provided to the customer for free or upon payment of specific service charges. In accordance with this embodiment, in the event a customer wishes to withdraw funds from the account (whether to obtain currency, transfer to another account or payment for goods/services) in an amount greater than that which exists in the account, the account provider may supply the funds to the customer.

In one or more embodiments, the account provider may charge the customer a specific fee for utilizing the credit line, such as a per usage fee, interest or the like. In one or more embodiments, after a particular transaction which exceeds the amount of funds in the account, the account is frozen until sufficient funds are placed in the account or provided to the account provider to cover the funds deficiency.

One or more embodiments of the invention comprise apparatus for use in performing the above-described methods. As stated above, this apparatus may include an access media, such as a card, check, chip or the like. The apparatus may also include a wide variety of devices for interacting with the account provider and/or account. These devices may include some existing devices, such as existing bank teller machines, card reading devices, and data receiving and transmitting devices.

In one or more embodiments, a customer is permitted to establish and interact with their account via a website or similar on-line access. The website may include a graphical user interface designed to provide information to the customer and prompt and accept that information. The website may have multiple levels or pages. For example, the website may have a home page or “log-in” page which prompts a customer to either identify that they are a new customer and wish to establish or activate an account or identify themselves as an existing customer and have them provide the requisite account information.

If the customer is a new customer, the customer may be sent to a webpage at which information is provided to the customer about the various accounts which may be established. This or other pages may include prompts for providing the data necessary to establish an account.

If the customer is an existing customer and provides the necessary information to access the account (as in Step S3-S5 set forth above), then the customer may be presented with a menu page. At this page the customer may be selected with a menu of items from which to select. These items may be similar to those of steps S7-10. For example, a customer may be provided with a “manage account” item. Upon selecting this item, the customer may be presented with a number of sub-menu items. These items may comprise those items identified in steps S9a-f.

In one or more embodiments, a webpage may display account information for more than one account belonging to a customer. A variety of means may then be presented to the customer for use in manipulating these accounts. For example, a customer may then be permitted to “drop and drag” funds or the like from one account to another.

In one or more embodiments, the account provider has one or more devices adapted to store account information and receive and transmit account data, data representing finds transfers and the like. The account provider may have a system which includes a data storage device, a data input device and a data transmitting device. The data storage device may comprise one or more hard drives or similar elements used to store account data. Modems, servers or similar devices may be used to transmit and receive data. This system may include one or more processors arranged to process data.

The devices used to implement the present invention may be incorporated into existing systems facilitating monetary and commercial transactions. For example, the access media associated with an account in accordance with the present invention may be utilized with current card-reading devices.

In accordance with one or more embodiments of the invention, an account provider may issue accounts associated with access media which are available for purchase by customers. For example, an account provider may associate an account with an access media. The access media may have associated therewith an expiration date, account data and a maximum value. A customer may “purchase” the account and associated access media at a retail location. When the account provider is a bank, the bank may place access media on sale at retail locations such as grocery and retail stores.

A customer purchases the account and card by paying the retailer (who in turn pays the account provider). In one or more embodiments, the customer may thereafter access the account by activating the account. This may comprise calling the account provider after purchase. At that time, the account provider may provide the customer with an access code for use in using the access card. The access code could be provided on the card, but this arrangement has added security in that the account provider can ensure that the account is only accessed once it has been paid for.

In this embodiment, a customer may conveniently obtain a “pre-paid” account for themselves or for another party. The account may be used in similar fashion to a credit or ATM card, permitting purchases from any vendor and permitting access to cash from any of a variety of cash-dispensing locations.

It will be noted that in this embodiment, the step of establishing the account is generally accomplished by the account provider without input from the customer. In one or more embodiments, after purchasing or obtaining the access card, a customer may be required or permitted to provide additional information in order to access the account.

It is preferred that the access card indicate the expiration date of the access media. If the access media and associated account is expired, the purchase is not permitted. If the access media is about to expire, the customer may purchase it and, if the customer wishes to extend the expiration date, contact the account provider after purchase to do so. In one or more embodiments, the expiration data may not be printed on the access media, but when it is purchased scanned, read or the like by the vendor to ensure that it is still valid. When a purchase of an access media is made, the expiration data may then be reset a predetermine time from the purchase, with this information scanned onto the card or otherwise associated with the account.

In the above-described arrangement, each access media, once paid for, generally has the same characteristics as cash. A customer may pay for goods using the purchased access media. A customer may deposit the funds associated with the access media into another account, or transfer it to another party.

The present invention has numerous benefits and advantages. First, an account of the present invention is configured to permit minors to make financial transactions. In accordance with the invention, a debit account is established by or for the minor. Because of the existence of the funds in the account, a minor may complete a transaction without concern to the account provider/financial institution that the minor will pay for goods.

In one or more embodiments, this arrangement permits a customer to “buy” an account for use by another person in a fixed amount. In this manner, the account may be used as a gift. This arrangement has the advantage that the recipient of the account can utilize the funds associated with the account to make a purchase or pay for goods/services from essentially any location. The recipient may purchase goods on-line or at a store. The recipient is not limited to a particular store or mall.

The customer may also utilize one or more of the accounts in similar fashion to travelers checks. Because the funds associated with the accounts are different, a loss such as by theft of a single access media does not affect the remaining funds. For added security, each access media may have a different access code.

Parents and others may arrange an account for their children. The children are not permitted to spend more money than their parents provide, because of the arrangement of the account. On the other hand, the parents can provide their children with a convenient means for paying for items even though they may be located a great distance apart. The parents may also access the account to track purchases and other transactions by their children. The parents may also arrange the account as an “allowance” account, where funds are placed into their children's account at predetermined intervals without specific action by the parents or children at the time of each deposit.

The methods and accounts of the present invention has several safety features. Because the account expires after a predetermined time, the risk that a thief may find and be able to use a lost access card is reduced. The account is associated with a unique account signature which is generated from data which is difficult to obtain.

The methods and accounts permit a wide range of transactions, including a number of very specific transactions which are not presently facilitated. For example, a vendor may establish promotional accounts for current and potential customers. One advantage of a promotional account is that a large company may establish accounts which customers can use at one or more of their stores located in different areas. For example, a retailer having outlet in Los Angeles and New York may issue cards associated with accounts for use by customer at either location. This arrangement is also advantageous for franchisees: the franchiser may sponsor a promotion for their franchisees whereby the discount or amounts provided to the customers are paid for by the franchiser.

A promotional account may also be a prize or award. A vendor may award an account to one or more customer who win a contest or drawing or the like. A vendor may also arrange the promotional account with an expiration date requiring the customer to utilize the account within a predetermined time.

A customer may establish a charity account for themselves, or a charity may establish an account for a customer. For example, a charity may seek donations from customers in the form of deposits into a charity account established by the charity for the customer.

In one or more embodiments, a customer or other user of a promotional account may be prevented from any account activities except use of the account to facilitate a purchase. The customer or user to whom the account is issued may be prevented from obtaining funds from the account (such as cash) or viewing data associated with the account such as the remaining balance or the like. A customer may also be prevented from merging the account or adding finds to the account. On the other hand, a vendor may be permitted to track all purchases and other uses of promotional accounts. In this manner, the vendor can obtain important data regarding the customer, including their spending habits, spending locations and similar information.

A business may use the account for business to business transactions. For example, a business may set up a master account and a number of sub or allowance accounts. The business may use the accounts to pay suppliers of goods and services. The master account may comprise a main account for the business and each allowance account an account relating to a particular vendor or project. Commensurate with billing or an accounting period, the business may have arranged an automatic transfer of funds from the master account to one or more of the allowance accounts, and from one or more of the allowance accounts to each particular supplier for their bill.

As indicated above, in one embodiment, account information is obtained via an RFID detector. The account information may be to a simple discount or reward account or program, or may be fund account information such as for a funds account as described above. Thus, a retailer or other entity may establish a simple discount or reward account or program and/or funds accounts. For example, a consumer may be permitted to established a funds account and that same account may also entitle the consumer to discounts or rewards.

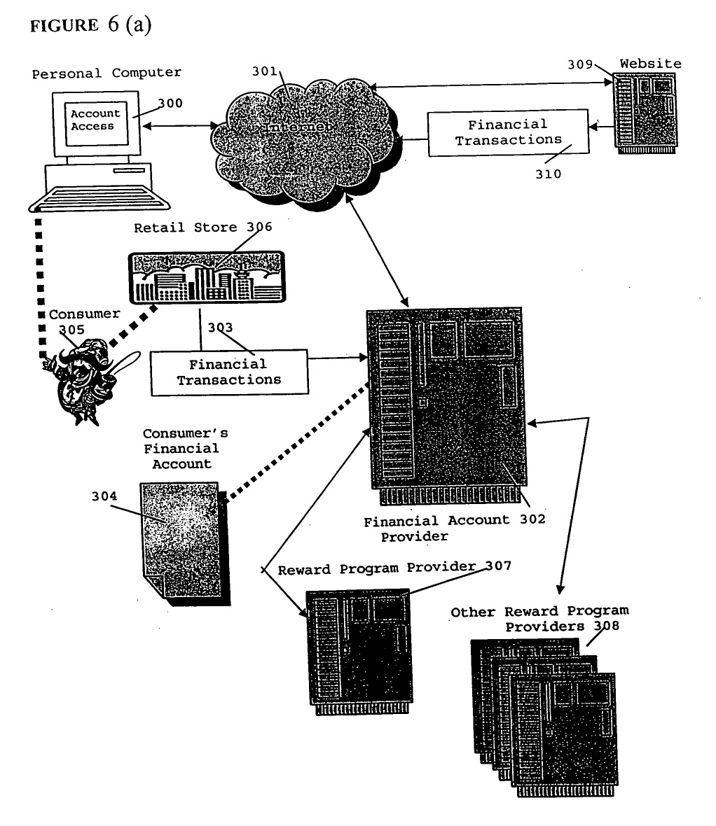

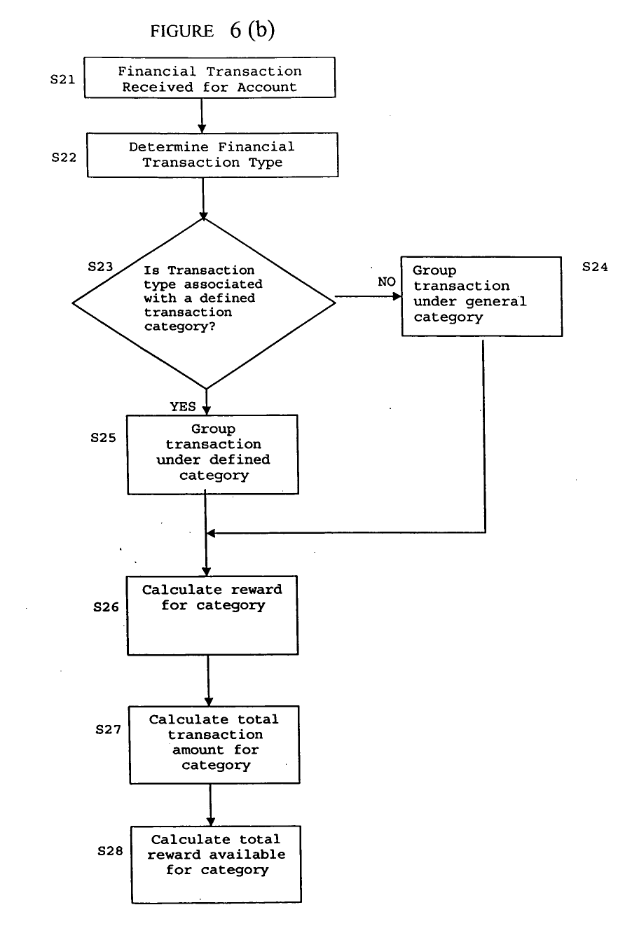

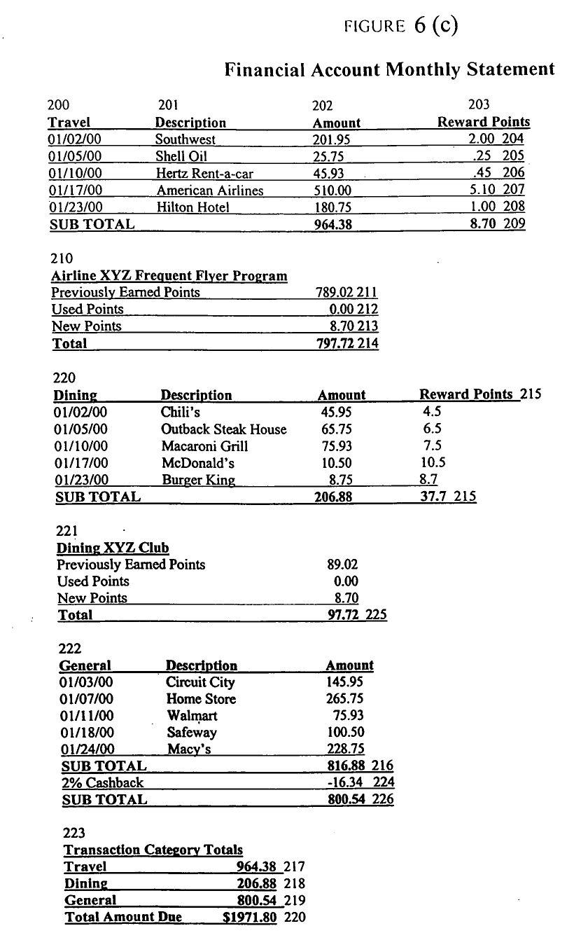

Another aspect of the invention will be described in FIG. 6(a)-(c). This aspect of the invention comprises one or more methods and systems for associating a plurality of reward programs with a single financial or reward account. Table I below illustrates one embodiment of an association between specific transactions grouped into transaction categories, which categories are then associated with a specific reward program. In a preferred embodiment, the financial account includes transaction grouping categories defined by the account provider whereby each of the transaction categories is associated with a single reward program.

TABLE I

| Transaction Categories | Reward Programs |
|---|---|
| Category A | Program 1 |
| Category B | Program 2 |
| . | . |
| . | . |
| . | . |

In alternative embodiments, a specific reward program may be applied to more than a single transaction category. In other alternative embodiments, a plurality of reward programs may be applied to a specific transaction category.

FIG. 6(a) is a schematic diagram of a system configuration where transactions are made by the consumer, tracked by the financial account provider and accessed by the consumer over the Internet.

Financial transactions 303 result from the use of the financial account 304 (such as one or more of the accounts described in detail above) or a reward or discount account, by a consumer 305. The transaction may be facilitated by the use of a credit card, debit card or smart card to make purchases at a retail store 306. The financial transactions 303 occur as the consumer 305 uses the consumer's financial account 304 to make purchases at the retail store 306. Information regarding the financial transactions 303 is transmitted to a financial account provider 302 and are placed into the financial account 304 belonging or assigned to the consumer 305.

The consumer 305 may then access their financial or reward account 304 over the Internet 301 from a personal computer 300. The financial account 304 access enables the consumer 305 to review the status of their financial account 304 and to manage a reward portion of their financial account 304. Such management of the reward programs associated with the consumer's financial account 304, by the consumer 305, includes the ability to redeem reward points for available rewards provided by the financial account provider 302 or reward program provider 307.

In other preferred embodiments, the consumer 305 may wish to use their financial account 304 for purchases or other transactions over the Internet 301 at a website 309. The financial transactions 310 are then transmitted over the Internet 301 to the financial account provider 302 and into the financial account 304.

The financial account provider 302 may have business relationships with a plurality of other reward program providers 308. In preferred embodiments a reward program provider 307 may exist for each of the reward programs associated with the consumer's financial account 304. In other preferred embodiments, the financial account provider 302 may provide the reward program(s). In other preferred embodiments, there may be a combination of reward programs provided by both the financial account provider 302, the reward program provider 307 and other reward program providers 308.

FIG. 6(b) illustrates the flow of financial transactions into defined transaction categories in accordance with an embodiment of the invention. Referring to FIG. 6(a), in a step S21, a financial transaction, resulting from the use of the financial account, is received by financial account provider for an individual's financial account.

In a step S22, the financial transaction is evaluated to determine the transaction type. The transaction type is preferably a form of identification which is used to associate or group individual transactions with or to financial transaction categories. For example, if the financial account were used to purchase an airline ticketed from Southwest Airlines, the resulting financial transaction of $201.00 could be assigned a “travel” transaction type. All travel transaction types would then be grouped under the “travel” financial transaction category. In a preferred embodiment, the financial account provider may define the financial transaction types and financial transaction categories. In alternative embodiments, the consumer may be enabled by the financial account provider to define their own financial transaction types and financial transaction categories. In general, particular characteristics or criteria may be utilized to identify the type of financial transaction. For example, the characteristics may include the name of the provider of the good or service or descriptions of particular goods and services.

In a step S23 a decision is made regarding which defined transaction category the financial transaction should be placed therein. This decision is based upon the defined associations between financial transaction types and financial transaction categories. The association is tested for each financial transaction received which is associated with a particular financial account.

In a step S24, if there is no defined category for the type of transaction being processed by the financial account provider the financial transaction may be associated with a general category. For example, if a transaction received has no transaction type defined for it and no association can be made between the transaction received and the defined transaction categories, the financial transaction may then be considered a general or “unclassified” transaction type and grouped in a general transaction category.

When the received transaction is associated with a defined transaction type, step S25 results. In a step S25, a specific transaction category has been identified for the type of financial transaction received and is grouped together with other financial transactions of the same transaction type into the associated transaction category.

In a step S26, a reward is calculated for the transaction received based upon the defined rules of the reward program associated with the transaction category with which the financial transaction is grouped.

In a step S27, the financial category total with which the financial transaction was grouped, is updated to reflect a new value based upon the financial transaction received. The update involves adding the received financial transaction with the associated financial transaction category to determine the new total transaction amount for the transaction category.

In a step S28, the financial category reward total associated with the particular financial transaction category is updated to reflect a new reward value based upon the financial transaction received. The update involves adding the received financial transaction reward value with the award total existing for the associated financial transaction category before that transaction. The result is a new total transaction reward amount for the transaction category. The total reward may be reward points, cash back, discounts, or other reward programs based upon the total transaction amount of the category and the corresponding rules of the associated reward program. In other embodiments, points, cash back, discounts, and other rewards may be based on the number of transactions whereby the total number of transactions relates to a transaction category.

Table II illustrates an example of a preferred embodiment with defined transaction groupings associated with defined reward programs. Each row of the table illustrates an example of a specific transaction category to reward program association whereby the defined transaction category, for example Dining, is associated with a specific reward program, for example the Diner XYZ Club.

TABLE II

| Transaction Categories | Reward Programs |
|---|---|
| Travel | Airline XYZ Frequent Flyer Program |
| Dining | Diner XYZ Club |
| General | 2% Cash-back over $250 |

In one or more embodiment, categorized financial transaction information is utilized to generate reward and other information. This information may be stored, such as in data files, and in one or more embodiments, may be presented to the customer. FIG. 6(c) is an example of a monthly financial account statement which may be mailed or viewed in electronic form by a customer. In this example monthly statement, three example transaction categories defined. These example transaction categories are Travel 200, Dining 220 and General 222. While this example of the preferred embodiment illustrates the use of three defined transaction categories for clarity, it will be appreciated that the preferred embodiment is not limited to only the three categories. Many other available transaction categories associated with the preferred embodiment are assumed and may be associated with the preferred embodiment of the financial account.

FIG. 6(c) illustrates the Travel 200 transaction category with an example listing of financial transactions of the travel type. The example listing provides a header for the Travel 200 transaction category establishing information columns as follows: Travel 200, Description 201, Amount 202 and Reward Points 203. Example transactions are illustrated in row format with information listed in each of aforementioned information columns. For example, travel transaction 204 occurred on Jan. 2, 2000 with a purchase to Southwest (Description 201) for an of 210.95 (Amount 202), earning 2.00 (Reward Points 203). Travel transaction 205 occurred on Jan. 5, 2000 with a purchase to Shell Oil for 25.75, earning 0.25. Travel transaction 206 occurred on Jan. 10, 2000 with a purchase to Hertz Rent-a-car for 45.93, earning 0.45. Travel transaction 207 occurred on Jan. 17, 2000 with a purchase to American Airlines for 510.00, earning 5.10. Travel transaction 208 occurred on Jan. 23, 2000 with a purchase to Hilton Hotel for 180.75, earning 1.00. The Subtotal Row 209 of the Travel 200 category illustrates Amount 202 of total Travel 200 transactions for an amount of 964.38, earning 8.70 Reward Points 203.

Associated with the Travel 200 transaction category is a Reward Program 210. In one embodiment, this Reward Program 210 is an Airline XYZ Frequent Flyer Program. Each row reflects the status of the Reward Program 210. Row 211 illustrates the total Previously Earned Points of 789.02. Row 212 illustrates Used Points of 0.00 and Row 213 illustrates New Points of 8.70. The Row 213 New Points value of 8.70 is from Reward Points 203 Subtotal Row 209 Travel 200 reward point calculation of 8.70. Row 214 lists a Total Reward Points value for Reward Program 210 associated with the Travel 200 financial transaction category to be 797.73 points.

Financial transaction category Dining 220 lists an example set of financial transactions associated with the Dining 220 transaction category. Subtotal Row 215 of transaction category Dining 220 lists the total amount of financial transactions to be 206.88, earning a total of 37.7 points. Reward Program 221 Dining XYZ Club is associated with financial transaction category Dining 220. Row 225 of Reward Program 221 lists the total amount of reward points of 97.72. The Reward Program 221 associated with the transaction category Dining 220, converts every $1 dollar spent on Dining 220 to Reward Program 221 point value of 0.1 reward points.

Financial transaction category General 222 lists an example set of financial transaction associated with the General 222 transaction category. Subtotal Row 216 of transaction category General 222 lists the total amount of financial transactions to be 816.88, earning a 2% Cashback award illustrated therein Row 224 of 16.34. Row 226 applies the Row 224 2% Cashback award to the General 222 transaction category subtotal Row 216, making the total amount owed illustrated in Subtotal Row 226 to be 800.54.

Transaction Category Totals 223 list the subtotals from each of the transaction categories: Travel 200, Dining 220 and General 222. In Row 217 the transaction category Travel 200 is listed with a subtotal amount of 964.38 from Travel 200 transaction category Subtotal Row 209. In Row 218 the transaction category Dining 220 is listed with a subtotal amount of 206.88 from Dining 220 transaction category Subtotal Row 215. In Row 219 the transaction category General 222 is listed with a subtotal amount of 800.54 from General 222 transaction category Subtotal Row 226. The total amount due Row 220 reflects a balance of 1971.80.

Each of financial transactions result in a reward based upon the rules of the particular reward program. Rules vary from program to program and are defined by the account or reward program provider. The example illustrated in FIG. 6(c), defines XYZ Airline Frequent Flyer Reward Program 210 associated with the transaction category Travel 200. The example Reward Program 210 converts every one $1 dollar spent on Travel 200 type transactions to a 0.01 reward points. The Diner 220 transaction category is associated with the Dining XYZ Club Reward Program 221. In this example, Reward Program 221 converts every one $1 dollar spent on Dining 220 type transactions to 0.10 reward points.

It will be appreciated that the financial transaction and reward information need not be arranged or generated specifically as illustrated in FIG. 6(c). For example, the information need not be arranged in the specific table format including rows. The information could be presented graphically, or otherwise.

After a specific number of points are accumulated in each of the associated Reward Programs 210 or 221, the consumer has various rewards to choose from which may be unique to the Reward Program 210 or 221. For Travel 200 Award Program 210, rewards may consist of free airline flights on specific airlines or free upgrades to first class. For Dining 220 Award Program 221, rewards may consist of free meals, 2-for-1 offers, and other discounts based on the total reward points accumulated. For General 222 transaction category, an example Cashback Reward Program is illustrated on Row 224. In preferred embodiment example, the consumer receives 2% Cashback on General 222 type transactions. In other embodiments, tiered reward programs, fixed dollar discounts, different percentages of cash-back depending upon the amount of the transactions, or credits for merchandise after a certain number of transactions have occurred may be defined as the preferred embodiment Reward Program.

In the preferred embodiment example, the consumer may wish to redeem points associated with their Travel 200 transaction category for a free flight to Timbuktu. The consumer accesses their account over the Internet using their home computer and selects their reward. Upon selection of the trip to Timbuktu, their financial account Reward Program used is updated to reflect the use of the reward points for the flight to Timbuktu.

In yet another alternative embodiment, the consumer may customize their financial account transaction categories with reward program associations they choose. Such embodiments provide the consumer with additional flexibility and incentives targeted towards the consumer's personal spending habits and behavior.

Transaction categories in other preferred embodiments may include financial transactions types associated with specific expenditures for example: clothing, music, grocery, furniture, housing, and vacation rentals. Each of these transaction types becomes a defined category and may be associated with a specific reward program.

In other embodiments, these transaction categories may be broken into more detailed subgroup transaction categories. For example, if grocery were a financial transaction category, it may have subgroups for certain categories of groceries such as meat, dairy, produce, and the like. Each of these subgroups may also have its own reward program, each of which is managed independently from the other groups and subgroups.

In one embodiment, a customer may be permitted to manually categorize or re-categorize a particular financial transaction. For example, if a particular financial transaction is mis-categorized, the customer may be permitted to move or re-assign in to an appropriate category. The financial account provider may impose rules for these activities.

In other alternative embodiments, the consumer may wish to move reward points from one transaction category reward program to another. In such an embodiment, the consumer may wish to convert a certain number of travel reward points to dining reward points in order to qualify for a specific dining reward of interest to the consumer.

As indicated, a consumer may be permitted to merge accounts or reward information, such as from reward accounts, such as illustrated in FIG. 4 and described above.

It will be understood that the above described embodiments of apparatus and the methods therefrom are merely illustrative of applications of the principles of this invention and many other embodiments and modifications may be made without departing from the spirit and scope of the invention as defined in the claims.

1. A financial transaction system including integrated detection of reward or discount entitlement comprising:
a point of sale terminal at which financial information is gathered from a payment media, said point of sale terminal configured to transmit payment information to a remote location for verification;
one or more RFID transponders configured to provide reward information;
an RFID reader associated with said point of sale terminal, said RFID reader configured to read said reward information from an RFID transponder located in the vicinity thereof, said RFID reader configured to provide said reward information to said point of sale terminal for use in determining eligibility for a reward or discount associated with a commercial transaction processed by said point of sale terminal.

2. The system in accordance with claim 1 wherein said RFID transponder is associated with said payment media.

3. The system in accordance with claim 2 wherein said RFID transponder is associated with a carrier, said carrier affixed to said payment media.

4. The system in accordance with claim 3 wherein said payment media comprises a magnetic stripe card and said carrier comprises a support including adhesive affixing said transponder to said card.

5. The system in accordance with claim 1 including an interface between said RFID reader and said point of sale terminal.

6. The system in accordance with claim 1 wherein reward information comprises an account code.

7. The system in accordance with claim 1 including a retailer system, said retailer system including at least one storage device storing account information, said retailer system configured to compare reward information to said account information in order to determine eligibility to said reward or discount.
